(19) United States
(12) Patent Application Publication
(10) Pub. No.: US 2007/0145733 A1
(43) Pub. Date: Jun. 28, 2007

(54) Co-branded ticket coverings and methods

(76) Inventor: James H. Eisenberg, Newport Beach, CA (US)

Correspondence Address: Rutan & Tucker, LLP.;Hani Z. Sayed, 611 ANTON BLVD, SUITE 1400, COSTA MESA, CA, 92626, US

(21) Appl. No.: 11/453,730

(22) Filed: Jun. 14, 2006

Related U.S. Application Data
(60) Provisional application No. 60/692,071, filed on Jun. 17, 2005.

(51) Int. Cl. B42D 15/00

(52) U.S. Cl. 283/53

(57) ABSTRACT

A ticket assembly that can be used to gain entry to an event comprises a ticket has: a first branding indicia; and a polymeric covering over the ticket that includes a co-branding indicia. The first branding indicia is preferably that of a sports team, musician, or other participant in the event, and the co-branding indicia is that of an entity largely or entirely unrelated to the event, including for example a ticket re-seller, manufacturer, distributor, marketer, professional service provider, lobbyist, builder, or transporter. The ticket assembly can advantageously include an Internet website or other link at which the attendee can maintain a history of their attendance at various events, include notes regarding the events, pictures and video clips relating to the event, and so forth. Access to that information can be granted to friends, family, business associates, and so forth.

This application discloses improvements relative to the event memorabilia holders described in U.S. patent application Ser. No. 10/652,825 filed Aug. 28, 2003, U.S. provisional application No. 60/501,632 filed Sep. 9, 2003, U.S. provisional application No. 60/550,170 filed Mar. 3, 2004, U.S. provisional application No. 60/572,505, filed May 18, 2004, and U.S. provisional application No. 60/575,302, filed May 28, 2004. These and all other referenced patents and applications are incorporated herein by reference in their entirety. Where a definition or use of a term in a reference, which is incorporated by reference herein is inconsistent or contrary to the definition of that term provided herein, the definition of that term provided herein applies and the definition of that term in the reference does not apply.

### BACKGROUND OF THE INVENTION

My previous applications in this field, listed above, disclosed embodiments regarding: (a) dimensions of ticket and other memorabilia holders; and (b) provision of such holders at a ball game or other event. What has now been appreciated is that there is a substantial need for intermediate suppliers of tickets (between the original seller and the attendee) to brand the tickets they provide in a permanent and attractive manner.

### SUMMARY OF THE INVENTION

The present invention provides systems and methods in which a ticket assembly that can be used to gain entry to an event comprises a ticket having a first branding indicia and a polymeric covering over the ticket that includes a co-branding indicia.

Of particular interest are sporting events, concerts, plays, movies, and other public events. The first branding indicia is preferably that of a sports team, musician, or other participant in the event, and the co-branding indicia is that of an entity largely or entirely unrelated to the event, including for example a ticket re-seller, manufacturer, distributor, marketer, professional service provider, lobbyist, builder, or transporter. In that manner, for example, a ticket re-seller such as Premier,™ Ticket Master,™ Coast to Coast Tickets,™ and The Ticket Company,™ can permanently brand the tickets they sell, and thereby continue to advertise their ticketing service. In a further example, a law firm that provides tickets to its clients or prospects as part of its marketing efforts can arrange to have the tickets coated with a clear plastic permanent covering that includes their own name, or contact information.

In particularly preferred embodiments the ticket assembly can advantageously include an Internet website or other link at which the attendee can maintain a history of their attendance at various events, include notes regarding the events, pictures and video clips relating to the event, and so forth. Access to that information can be granted to friends, family, business associates, and so forth.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIGS. 1-7 are plan views of ticket assemblies according to aspects of the present invention.

FIGS. 8 and 9 are printouts from the StubShield website.

### DETAILED DESCRIPTION

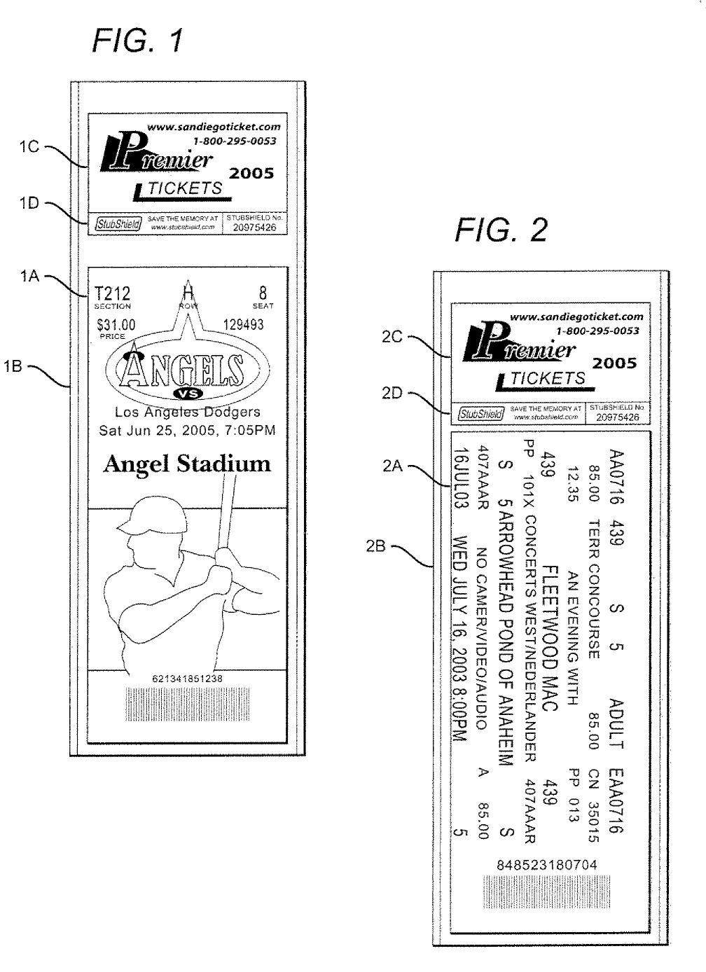

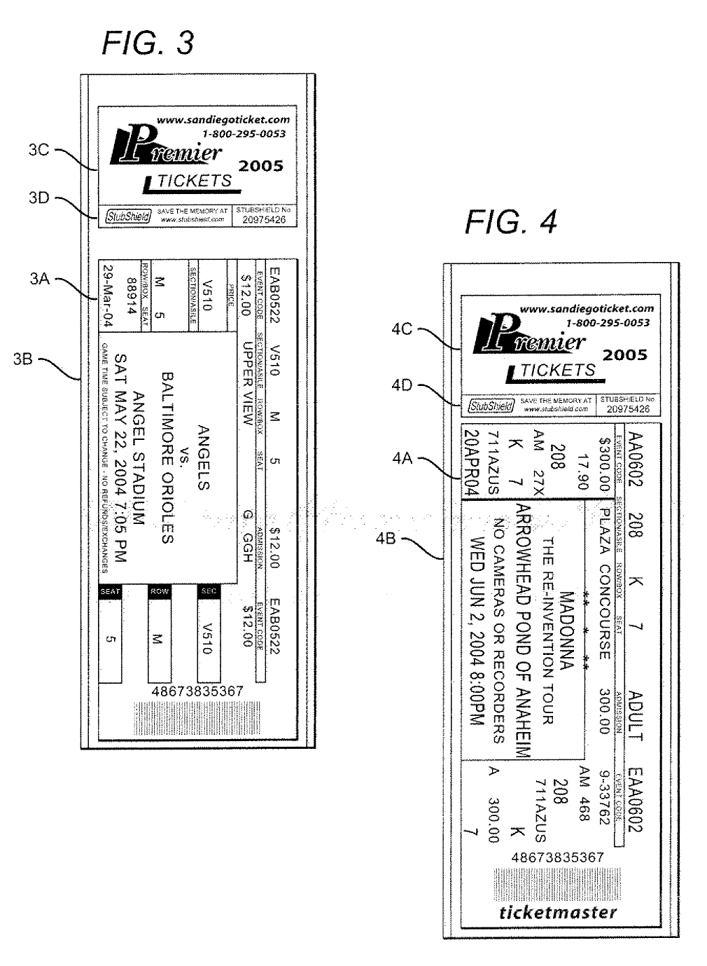

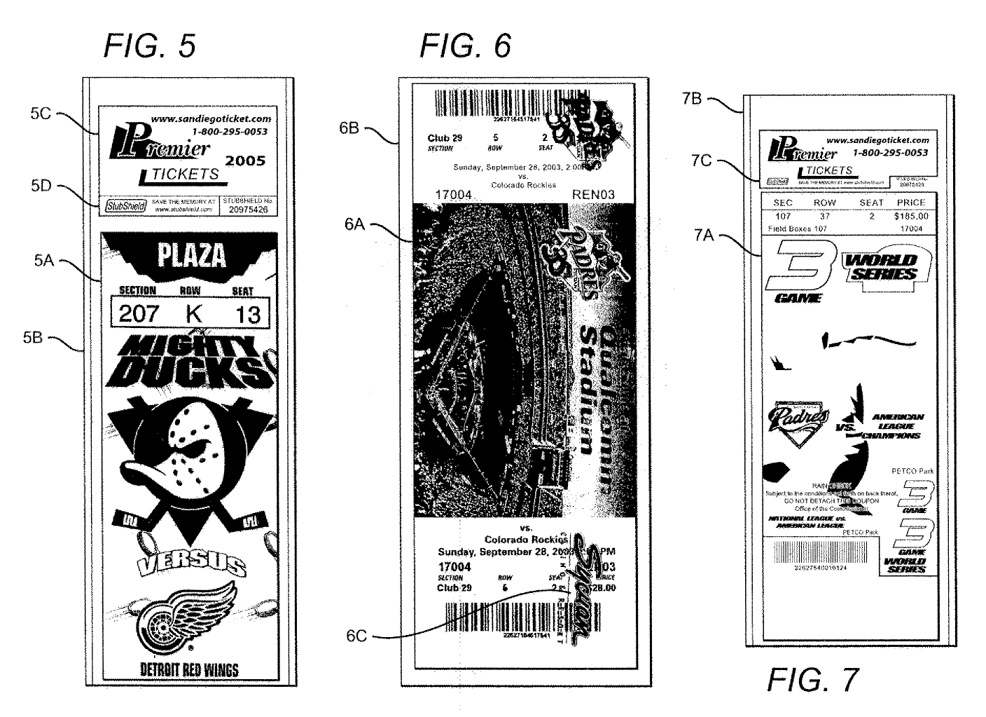

In each of FIGS. 1-7, tickets 1A-7A are permanently sealed in a plastic casing 1B-7B. There is an invisible adhesive coating on the inside of the casing that attaches to the ticket, and would cause damage to the ticket if one were to try to remove the ticket from the casing. In the most preferred embodiment, the casing does not have any adhesive and the ticket is not damaged by removal from the casing. The casings are sufficiently clear that the ticket bar code can be scanned using an optical scanner.

On the outside of each casing is a sticker 1C-7C that identifies an intermediate provider of the ticket, in this case Premier Tickets™ (FIGS. 105 and 7) or Sycuan™ (FIG. 6). In FIGS. 1-7, the stickers include the name of the intermediate provider, and its logo or other indicia, and in FIGS. 1-5 and 7 the stickers also include contact information including the provider's website and telephone number.

In addition, the stickers on ticket assemblies of FIGS. 1-5 and 7 also include a section 1D-5D, 7D that displays the name of a company (StubShield™) that hosts a website (www.stubshield.com) at which an attendee can maintain a history of their attendance at various events, include notes regarding the events, pictures and video clips relating to the event, and so forth. That section also includes an identifier that can be unique to each ticket assembly, and can be used as a registration key or other identifier at the website.

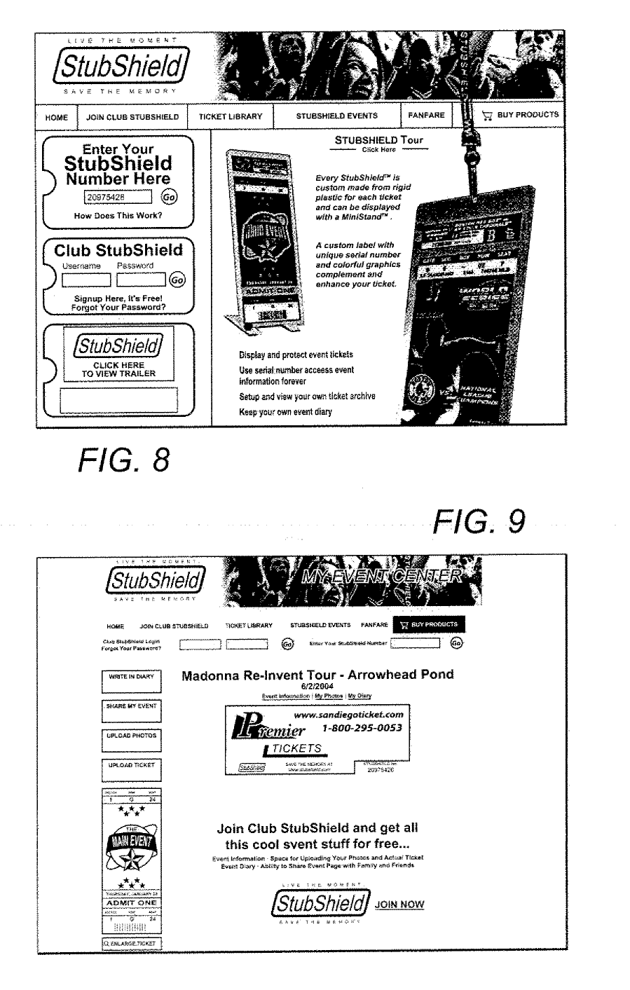

FIGS. 8 and 9 are printouts from the StubShield website.

It is further contemplated that the branding indicia on the ticket itself is related to at least one of: (a) a participant in the event; and (b) an event hosting facility; and that the co-branding indicia is not directly related to either the participants or the hosting facility. Thus, for example, the co-branding indicia could be that of Coca-Cola™ or other beverage company, or PowerBar™ or other non-beverage food.

The participant(s) in the event is/are contemplated to include especially sporting figures, sports teams, musicians and other performance artists, public lecturers and other speakers, politicians at political rallies, company heads, and so forth. The events are contemplated to include all manner of public, as well as private events, and whether or not there is an admission charge.

Event hosting facilities are contemplated to include stadiums, concert halls, auditoriums, open air theatres, movie theatres, and all other relevant sites.

The intermediate selling entities are contemplated to include all manner of ticket resellers, any company or individual that uses tickets to events as part of their marketing, and even companies or individuals that have nothing to do with events or tickets for events.

It should be apparent to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps could be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A ticket assembly that can be used to gain entry to an event, comprising:
a branding indicia related to at least one of: (a) a participant in the event; and (b) an event hosting facility;
a polymeric covering over the ticket that: (a) includes a co-branding indicia; and (b) is sufficiently clear to allow optical scanning of the ticket through the covering.

2. The ticket assembly of claim 1, wherein the participant comprises at least one of a sporting team and a musician.

3. The ticket assembly of claim 1, wherein the event comprises at least one of a sporting event and a concert.

4. The ticket assembly of claim 1, wherein the branding indicia is that of a sports franchise.

5. The ticket assembly of claim 1, wherein the branding indicia is that of the event hosting facility.

6. The ticket assembly of claim 1, wherein the purchaser is a ticket re-seller, and the co-branding indicia is that of the ticket re-seller.

7. The ticket assembly of claim 1, wherein the co-branding indicia is not printed directly on the ticket.

8. The ticket assembly of claim 1, wherein the co-branding indicia is that of a food provider.

9. The ticket assembly of claim 1, wherein the purchaser is an attendee of the event.

10. The ticket assembly of claim 1, wherein the covering attaches the ticket using a substance that prevents removal of the ticker from the covering without damaging the ticket.

11. The ticket assembly of claim 1, wherein the covering includes a unique identifier.

12. The ticket assembly of claim 1, wherein the covering includes an address of an electronically accessible site.

13. The ticket assembly of claim 12, wherein the electronically accessible site maintains a history that includes identification of the event.

14. The ticket assembly of claim 13, wherein the electronically accessible site provides an interface through which a person can record personal information regarding the event.

15. The ticket assembly of claim 14, wherein the personal information is selected from the group consisting of a name of an attendee at the event, textual information, and images.

16. The ticket assembly of claim 1, where the covering also includes a contact information of an intermediate provider of the ticket to an attendee.

17. A method of marketing, comprising:
an entity other than the participant in the event and the event hosting facility arranging for a ticket assembly of claim 1 to include as the co-branding indicia an indicia of the entity;
the entity providing the ticket assembly to an attendee for use at the event.

18. The method of claim 17, further comprising the entity providing the ticket assembly to the participant at no cost.

19. The method of claim 17, further comprising the entity selling the ticket assembly to the participant.

20. The method of claim 17, wherein the participant is a customer of the entity for goods or services other than event tickets.

21. The method of claim 17, wherein the entity is selected from the group consisting of a manufacturer, a distributor, a marketer, a professional service provider, a lobbyist, a builder, and a transporter.
